(19) United States
(12) Patent Application Publication
(10) Pub. No.: US 2013/0302762 A1
(43) Pub. Date: Nov. 14, 2013

(54) Noise Induced Brain Plasticity

(71) Applicants: Xiaoming Zhou, San Francisco, CA (US); Michael Merzenich, San Francisco, CA (US); Etienne de Villers-Sidani, Montreal (CA)

(72) Inventors: Xiaoming Zhou, San Francisco, CA (US); Michael Merzenich, San Francisco, CA (US); Etienne de Villers-Sidani, Montreal (CA)

(73) Assignee: THE REGENTS OF THE UNIVERSITY OF CALIFORNIA, Oakland, CA (US)

(21) Appl. No.: 13/704,944

(22) PCT Filed: Jun. 22, 2011
(86) PCT No.: PCT/US11/41510

§ 371 Date: Apr. 10, 2013

Related U.S. Application Data
(60) Provisional application No. 61/359,292, filed on Jun. 28, 2010.

(51) Int. Cl. G09B 5/00

(52) U.S. Cl. CPC G09B 5/00
USPC 434/156; 434/319

(57) ABSTRACT

The present disclosure relates to methods and tools that induce brain plasticity. The method involves presenting to an individual continuous noise over a period of time, and thereafter, providing the individual with tone sensitivity training or language training.

### CROSS-REFERENCE TO RELATED APPLICATIONS

This application claims the benefit of U.S. Provisional application Ser. No. 61/359,292, filed on Jun. 28, 2010, which application is incorporated herein by reference in its entirety.

### INTRODUCTION

Sensory experiences during the “critical period” have major and long-lasting impacts on brain processing that have been argued to enable individuals to adapt to a wide range of environments. In the auditory system, there is a well-defined, acoustic environment-dependent critical period in the primary auditory cortex. Within this developmental epoch, cortical representations of spectral, temporal, intensive or combined features of sound can be greatly distorted (plausibly specialized for their representations) by passive exposure to sound stimuli. These environment-sound-specific changes in selective cortical responses and cortical circuitry are substantially retained into adulthood. Beyond the closure of the critical period, non-attended or passive exposure to sounds has little plastic consequence for auditory cortex (A1); cortical modification requires that the older animal be in a learning (attended; rewarded; novel-stimulus) behavioral context.

In this special early epoch, the plasticity of the brain has been argued to be specifically enabled by immature cortical machinery that operates with relatively long time and space constants, with temporally unregulated modulatory facilitation of synaptic plasticity, with physical synapses and extracellular matrices in an infantile state that facilitates synapse mobility and plasticity, and with noisy and temporally dispersed activities attributable to the still primitive development of cortical connections and myelin. All of these aspects of cortical structure and function change (mature) in the transition to adulthood.

Altering the cortical balance of inhibitory-excitatory strengths can result in a “residual capacity” for critical period-like plasticity in the adult visual cortex. For example, an epoch of ocular dominance plasticity mimicking that recorded in the infant brain can be re-opened by maintaining an adult rat for an extended period in the dark.

In the present disclosure, it is shown that post-critical period rats in an environment of moderate-level noise can re-establish a period of sound exposure-driven plasticity in their primary auditory cortices, and that this natural functional reversal is accompanied by a complex series of parallel changes in the cortex that signal a partial reversal from the adult functional status back in the direction of a less-mature A1.

### SUMMARY

The present disclosure relates to methods and tools that induce brain plasticity. The method involves presenting to an individual continuous noise over a period of time, and providing the individual with language training after the presenting step.

Chronic exposure to moderate-level acoustic noise can reverse the maturational changes that mark the infant critical period-to-adult transition in the primary auditory cortex. Noise exposure then reinstate critical period plasticity, thus making the auditory cortex more receptive to subsequent training

### BRIEF DESCRIPTION OF FIGURES

FIG. 1. Changes in cortical responses following chronic noise exposure. Panel A, Experimental time lines for noise exposed (NE) and age-matched naïve control rats. Pw, postnatal week. Panel B, Representative characteristic frequency (CF) maps recorded from A1 of NE and control rats. The color of each polygon in these maps indicates the CF for neurons recorded at that site (see color scales). Polygons are Voronoi tessellations representing each neuronal middle-cortical-layer response sample site, generated so that every point on the cortical surface was assumed to have the characteristics of its closest neighbors. A, anterior; D, dorsal. Panel C, Comparisons of the percentages of A1 areas that were tuned to different frequency ranges (left) and the average receptive field bandwidths (BW20s; right) between NE and control rats. Bin size=one octave. *, p<0.00012. Error bar represents SEM. Panel D, Average temporal modulation-transfer functions (tMTFs; upper left), average highest temporal rate at which cortical responses were at half of their maximum (i.e., f_{h1/2} upper right), f_{h1/2} distributions (lower left), and average vector strengths measured at different pulse repetition rates (lower right) for all recordings in NE and control rats. *, p<0.02-0.00001. Panel E, Average normalized cross-correlation functions (left) and Z-score of neuronal firing synchrony as a function of distance between the two recording sites (right) for NE and control rats. *, p<0.005.

FIG. 2. Dot raster plots of cortical responses to pulse trains of different repetition rates recorded from NE (upper) and age-matched naïve control (lower) rats. The gray horizontal dashes indicate pulse duration. The insert shows tMTF for each raster plot example.

FIG. 3. Average Z-scores of neuronal firing synchrony across representative A1 regions for low-(<3.1 kHz), middle-(3.1-9.5 kHz), and high-(>9.5 kHz) frequencies for NE and control rats. *, p<0.035-0.00001. Error bar represents SEM.

FIG. 4. Restoration of normal response properties for NE rats after being returned to a normal environment. Panel A, Experimental time lines for different groups of rats. NE (8 weeks), NE rats that were returned to a normal auditory environment and mapped at Pw22, i.e., 8 weeks after the end of noise exposure. Panel B, Average BW20 and f_{h1/2} of NE rats measured immediately or 8 weeks after noise exposure, illustrating with age-matched naïve control rats. *, p<0.001. Error bar represents SEM.

FIG. 5. Long-term impacts of tone exposure on A1 representation. Panel A, Experimental time lines for different groups of rats. NE+TE (7 weeks), NE+TE rats were returned to a normal auditory environment and mapped at Pw22, i.e., 7 weeks after the end of tone exposure. Panel B, Percentages of A1 areas tuned to 7 kHz±0.25 octaves measured at one week or 7 weeks after the end of the tone exposure, illustrating with age-matched naïve control rats. *, p<0.001 compared to control rats. Error bar represents SEM.

FIG. 6. Noise exposure reinstates critical period plasticity in A1. Panel A, Experimental time lines for noise exposed plus tone exposed (NE+TE), TE-control and age-matched naïve control rats. Panel B, Representative CF maps obtained from NE+TE, TE-control, and control rats. Outlined polygons indicate recording sites with CF of 7 kHz±0.25 octave. Panel C, Distributions of CFs plotted against a normalized tonotopic axis in different groups of rats. Note that there were increased A1 sites that were tuned to 7 kHz in NE+TE rats (dashed line), but not in TE-control rats, when compared to control rats. Panel D, Differences in percentages of A1 areas tuned to different frequency ranges for NE+TE or TE-control rats versus control rats. *, p<0.038-0.00001.

FIG. 7. Noise exposure reinstates cortical period plasticity in A1 of rats older than one year. Panel A, Representative CF maps showing over-representation of 7 kHz for NE+TE rats older than one year compared to age-matched NE-control and naïve control rats (see FIG. 6, panel A for experimental time lines). Panel B, Distributions of CFs plotted against a normalized tonotopic axis for NE+TE (N=5), TE-control (N=4) and naïve control (N=5) rats. Panel C, Differences in percentages of A1 areas tuned to different frequency ranges for NE+TE or TE-control rats versus control rats. *, p<0.0001.

FIG. 8. Transient tone exposure beyond the critical period does not alter A1 tonotopy. Panel A, Experimental time lines for different groups of rats. Note that TE rats were exposed to 7-kHz tones at Pw8 which is the onset of noise exposure for NE rats (see FIG. 1, panel A). Panel B, Differences in percentages of A1 areas tuned to different frequency ranges for TE (N=4) versus control (N=4) rats. Note that the percentage of A1 area representing each frequency range in TE rats was comparable to that in control rats (t-test, all p>0.3).

FIG. 9. Molecular changes in A1 induced by noise exposure. Panel A, Noise exposure significantly decreased expression levels of GABA_{A} α1 and β⅔ in NE rats (N=7) compared to age-matched naïve control rats (N=5). See FIG. 1, panel A for experimental time lines of NE and control rats. The inserts show representative western blots. Error bar represents SEM. *, p<0.004. Panel B, Noise exposure did not change expression level of AMPA GluR2, or the ratio of NMDA NR2a/NR2b in NE rats (N=9) compared to control rats (N=6). Panel C, Noise exposure significantly decreased expression level of MBP (N=7 for NE rats and 5 for control rats) but increased that of BDNF (N=10 for NE rats and 6 for control rats). *, p<0.04. All but the BDNF values were normalized against control rats.

FIG. 10. Expression levels of GABA_{A} α1 and β⅔ and MBP in the visual cortex. The inserts show representative western blots. Note that no significant differences were observed between NE (N=6, 6 and 5, respectively) and control (N=6, 5 and 6, respectively) rats. All values were normalized against control rats. Error bar represents SEM.

### DETAILED DESCRIPTION OF EXEMPLARY EMBODIMENTS

The present disclosure relates to methods and tools that induce brain plasticity. The method involves presenting to an individual continuous noise over a period of time, and providing the individual with language training after the presenting step.

Before the present invention and specific exemplary embodiments of the invention are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

When describing the methods and compositions of the present disclosure, the following terms have the following meanings unless otherwise indicated.

The term “cognition”, as used herein, refers to the speed, accuracy and reliability of processing of information, and attention and/or memory.

The term “brain plasticity”, as used herein, refers to the ability of brain to learn and/or relearn. Physiological processes that characterize plasticity involves the changing of neurons, the organization of their networks, and their function, including adding or removing connections or neurons.

The term “exposure to noise” or “noise exposure”, as used herein, refers to exposure to audio stimuli that are purely random and can include exposure to white noise (e.g. structured white noise).

As used herein, the term “white noise” refers to is a random auditory stimulus represented by waveform with a flat power spectral density. A white noise auditory signal contains equal power within a fixed bandwidth at any center frequency.

### Methods

The present disclosure provides methods and tools to induce brain plasticity. The method involves presenting to an individual continuos noise (e.g. white noise) over a period of time and, thereafter, providing the individual with tone sensitivity training, language training, and/or any training of the auditory cortex. The presentation of noise to the individual can reverse the maturation of the auditory cortex back to a more plastic state that is amenable to learning. Once brain plasticity is increased, the individual is more likely to receive and learn the training that follows. Essentially, relative to a matured brain, increased plasticity can better increase the potential of learning new skills and/or improving exisiting skills by restructuring neuronal networks. A language training that follows the presentation of noise, for example, can train or retrain a person to learn the new language. The individual may find that learning auditory skills, such as a language, can more effective after noise exposure than prior to the exposure.

Where the noise presented to the individual is white noise, the noise is a random auditory stimulus represented by waveform with a flat or mostly flat power spectral density, in which the power magnitudes are equal within a fixed bandwidth at any center frequency. In other words, sound stimuli of various detectable frequencies across a broad spectrum, all with similar or identical intensity combined can be a type of white noise exposed to the individual. Sources and the types of noises are varied and known in the art and can be used in the subject method. As long as the energy level across a broad frequency spectrum is essentially flat, the sound stimulus can be used as white noise in the subject methods. Broad frequency spectrum can range from about 0.1 to about 40 kHz, for example. The white noise presented to an individual in the subject methods can be structured white noise. “Structured white noise” or “structured noise” refers to a random or mostly random auditory stimulus with a non-uniform power spectral density (e.g. Poisson noise, Gaussian noise) and/or with some amount spectro-temporal correlations (noise produced by fans, 1000 different people talking simultaneously or by automobile traffic on freeways or bridges.

Noise can be synthetically generated by machines, e.g. laboratory apparatus, or recorded in a natural environment. Common natural sources of noises include, 1000 different people simultaneously talking, fans, automobile traffic on freeways or bridges, etc. The type of noise can also be categorized in terms of its distribution, such as Gaussian, Poisson, etc.

The noise is delivered continuously with a consistent inter-stimulus-interval (ISI). The ISI in pulses of noise is often a fraction of a second. The stimulus set can be delivered at a speed measured in pulse per seconds (pps). The stimuli in a set can be presented in about 1, about 2, about 2.5, about 3, about 3.5, about 4, about 5, about 6, about 7, about 8, about 10, about 12, about 15, about 20, about 25, up to about 30 or more pps. For example, the noise can be delivered at 5 pps. The noise can also be delivered at a loudness appropriate for the individual. Loudness can be expressed in sound pressure level (SPL) measured in decibels (dB) above a standard reference level. The standard reference level is about 20 μPa. Where the auditory stimulus is represented as a waveform, loudness is also referred herein as amplitude. Loudness can range from between about 1 to about 5, between about 5 to about 10, between about 10 to about 40, between about 40 to about 60, between about 60 to about 70, up to about 80 dB or more. For an individual with healthy hearing capability, loudness of the noise should be no more than about 85, no more than about 80, no more than about 75 dB or less. For example, in the subject methods, the noise can be delivered at a level of about 65 dB.

The duration of noise presentation to the individual can vary (e.g. depending on the magnitude of reversal or the individual). The duration can be less than 1 week, about 1, about 2, about 3, about 4, about 5, about 6, about 7, about 8, about 9, about 10, about 12, about 15, up to about 20 weeks or more. For example, the individual can be presented with a continuous noise for about 6 weeks.

After the exposure of an individual to continuous noise, the subject methods provide language training to the individual. Language training encompasses placing the individual in a normal auditory environment or in an environment desirable for the lifestyle of the individual. Language training also includes teaching the subject a new language. Teaching a language can include providing resources for the individual to speak, to read, to converse, to write, or any combination thereof, a language. For example, the subject can learn the pronunciation of vowels, consonants, words and/or syllables. Auditory training relating to phonemes known in the art and can be applied as language training in the subject methods. Details can be found in e.g., U.S. Pat. No. 6,290,504, U.S. Pat. No. 6,261,101, and U.S. Pat. No. 6,413,098, disclosures of which are incorporated herein by reference. The language may be completely previously unknown to the individual or insufficiently learned prior to employing the methods and tools of the present disclosure.

Training provided subsequent to noise exposure also encompasses training that increases sensitivity to a particular auditory frequency range. Exposure of an auditory stimulus in a particular frequency range to a plastic auditory cortex can expand the representation of that frequency in the auditory cortex. Certain individuals have difficulties differentiating sounds (e.g. frequencies, musical notes, or speech sounds, for example) because of a distorted auditory experience in early childhood or secondary to a neurological injury or cochlear injury. A dyslexic individual can also benefit from the subject methods. For example, a person who often confuses the sounds ‘b’ and ‘p’ could be exposed to strings of clear, well articulated ‘b’ and ‘p’ sounds at about 5-10 pps for about 1 week. These and other individuals can resort to trainings of this sort. In another example, if it is desirable for an individual to increase sensitivity to auditory stimulus of 7 kHz, the individual may be exposed to a 7 kHz tone at about 5 pps for about 1 week. The duration of this tone exposure is no more than about 1%, no more than about 5%, no more than about 10%, no more than about 20% or more of the duration of the noise exposure.

### Target Population

Individuals who can find use with the methods and tools of the present disclosure include people of any age or background where it is desirable to reverse the maturing and un-learn skills of the auditory cortex (e.g. A1). Circumstances where it is desirable include those in which re-learning from with a plastic state can bring great benefits to the individual.

One example population that can be targeted by the subject methods include young children who do not develop normal language representations. The subject methods can be useful for children at ages of less than about 4, less than about 3, less than about 2, less than about 1 year of age. For example, the child may be about 20 months old, 18 month old, or younger. Sub-optimal language development in children may be caused by substantial early hearing loss. Although the hearing loss may later be recovered, the children may not be able to relearn the language given the maturity stage of their auditory cortex. However, the subject methods can drive the brain back to a more plastic stage, for example through the application of a hearing aid or cochlear implant. Deaf children can also benefit from the subject methods for their speech development can be improved with a plastic auditory cortex.

Abnormal language development may also arise because of early brain injury due to a wide variety of possible causes, or through extreme language-exposure deprivation of an environmental (e.g., child of deaf, non-aural parents; very sparse language exposure as recorded, for example, in Romanian orphans; etc.) or medical (e.g., chronic, persistent middle ear infections) causes. It may arise through cortical epilepsy (a likely cause of regressive language abilities in autistic and other pervasively developmentally disordered children; or in Landau-Kleffner Syndrome and other childhood epilepsy conditions).

The subject methods and tools can also re-start the development of language abilities in impaired, older-aged individuals. Because the subject methods can reverse maturational processes and thereby re-establish a critical period of development, the environmental or medical problems that have forestalled normal language or reading development no longer apply. A language-specific phonemic representation can be quickly established by exposing the individual to the sounds of the language. Language and reading (and associated cognitive) abilities can be achieved with more ease for such an individual than one who does not employ the subject methods and tools.

### Computer System and Tools

The present disclosure provides an apparatus that acts like a hearing aid, except that it carries out the subject method of presenting a continuous noise (e.g., continuous white noise). The apparatus can include a form of cochlear implant, headphones, earphones, loudspeakers, and/or any similar electronic device. The apparatus can include an actuator that generates the continuos noise or language/tone training and a power source, optionally any one or more of the following: an amplifier, volume control, and/or some type of coupling to the ear such as an earmold. Amplifiers take the generated auditory signal and make it louder. The apparatus can be designed and configured as a behind-the-ear (BTE) hearing aid or inserted directly into the ear canal of a user (e.g. a cochlear implant. The actuator of the apparatus can include one or more speaker units.

The present disclosure can further contain computer program products that can carry out the subject method of inducing brain plasticity. The subject matter described herein may be embodied in systems, apparatus, methods, and/or articles depending on the desired configuration. In particular, various implementations of the subject methods described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g. buttons to turn on or off the white noise), and at least one output device (e.g. a speaker in headphones, earphones, and/or cochlear implant).

These computer programs (also known as programs, software, software applications, applications, components, or code) include machine instructions for a programmable processor, and may be implemented in a high-level procedural and/or object-oriented programming language, and/or in assembly/machine language. The program that executes methods of the present disclosure may be downloaded to the apparatus (e.g. computer, audio player, cochlear implant, etc.) by the individual from a remote source (server) or be stored in a “machine-readable medium”. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal.

The apparatus may optionally include one or more networks or other communications interfaces, such as a network interface for conveying testing or training results to another system or device. The apparatus may be connected to a computer (e.g. server) or mobile device. The connection between the computers and the server can be made via a local area network (LAN), a wide area network (WAN), open wireless (e.g. Bluetooth™), or through the Internet. The connection of the apparatus to another computer, for example, can allows information such as the type of continuous noise, the duration of continuous noise, and any other data pertaining to an individual's behavior, physiological (e.g. neurological) changes to be recorded, store, and/or transmitted from one location to another, e.g. a server. An administrator can review the information, download configuration and data pertaining to a particular individual, communicate feedback to the individual, and/or transmit instructions or data back to the individual's apparatus.

The application module executing the subject method may include one or more of the following: a) a continuous noise generation control program, module or instructions, for generating continuous noise at a selected setting, as described above for the subject method; b) an actuator control program, module, or instructions, for producing or presenting the continuous noise to an individual; and/or timing device to keep track of the duration of the continuous noise exposure; c) a program, module, or instructions for language/tone sensitivity training.

The application module may furthermore store data, which includes the measurement of physiological data of the individual, and optionally may also include analysis results and the like. Any of the programs described above may be stored or executed from more than one locations, e.g. more than one computer readable medium. For example, the continuous noise generation program may be executed remotely via a network while the actuator program may be stored and/or executed locally (e.g. cochlear implant).

As noted above, the subject method can be employed in order to induce brain plasticity and improve an individual's ability to learn new skills related to the auditory cortex. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results.

In one embodiment, there is provided a computer-readable storage medium for inducing brain plasticity in an individual, comprising instructions executable by at least one processing device that, when executed, cause the processing device to: (a) present to the individual with continuous noise over a period of time; and (b) provide said individual with tone sensitivity training or language training The noise may be structured noise. The noise may be presented at about 65 dB. The period of time may be about 6 weeks.

The following examples further illustrate the present invention and should not be construed as in any way limiting its scope.

### EXAMPLES

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### Materials and Methods

The following methods and materials were used in the Examples below.

All experiment procedures were approved under the Institutional Animal Care and Use Committee (IACUC) at the University of California, San Francisco.

Sound Exposure

Rats were placed in sound-shielded test chambers for noise or tone exposure (24 h per d). The continuous broadband noise was generated by a random noise generator (General Radio Company, Concord, Mass.) and amplified to a calibrated free-field sound level of 65 dB SPL. The energy level for noise was essentially flat across a broad frequency spectrum (0.1-40 kHz). Sound signal for tone exposure was a pulsed 7 kHz tone (50 ms duration tone pips with 5 ms ramps at 65 dB SPL, delivered at 5 pulses per second, pps). There was one second interval of silence between every five pulses to minimize adaptation effects. No distortion or substantial harmonic signal was found in the chamber when tonal stimuli were delivered. Rats were given free access to food and water under an 8-h light/16-h dark cycle. The weights and activities of exposed rats were continuously monitored, and compared with naïve control rats. No abnormalities in the behavior of exposed rats could be detected during sound exposure and their weights were comparable to age-matched naïve rats. Their activities during waking and their sleep behaviors indicated that the exposure stimuli were not stressful.

Cortical Mapping

Animals were initially anesthetized with an i.p.injection of sodium pentobarbital (50 mg/kg body weight). Throughout the surgical procedures and during the recording session, a state of areflexia was maintained with supplemental doses of dilute pentobarbital (8 mg/ml) injected i.p. The trachea was cannulated to ensure adequate ventilation and the cisterna magnum drained of cerebrospinal fluid to minimize cerebral edema. The skull was secured in a head holder leaving the ears unobstructed. After reflecting the right temporalis muscle, the auditory cortex was exposed and the dura was resected. The cortex was maintained under a thin layer of viscous silicone oil to prevent desiccation.

Cortical responses were recorded with parylene-coated tungsten microelectrodes (1-2 megohms at 1 kHz; FHC, Bowdoinham, Me.) in a shielded, double-walled sound chamber. Recording sites were chosen to evenly sample from the auditory cortex while avoiding blood vessels, and were marked on a magnified digital image of the cortical surface vasculature. At each recording site the microelectrode was lowered orthogonally into the cortex to a depth of ˜500 μm (layers 4 and 5), where vigorous stimulus-driven responses were recorded. Acoustic stimuli were generated using TDT System III (Tucker-Davis Technologies, Alachua, Fla.) and delivered to the left ear through a calibrated STAX earphone with a sound tube positioned inside the external auditory meatus. A software package (SigCal, SigGen, and Brainware; Tucker-Davis Technologies, Alachua, Fla.) was used to calibrate the earphone, generate acoustic stimuli, monitor cortical response properties online, and store data for offline analysis. The evoked spikes of a neuron or a small cluster of neurons were collected at each site.

Frequency tuning curves were reconstructed by presenting pure tones of 50 frequencies (1-30 kHz, 25 ms duration, 5 ms ramps) at eight sound intensities (0 to 70 dB SPL in 10 dB increments) to the contralateral ear in a random, interleaved sequence at a rate of 2 pps. The CF of a cortical site was defined as the frequency at the tip of the V-shaped tuning curve. For flat-peaked tuning curves, characteristic frequency was defined as the midpoint of the plateau at threshold. For tuning curves with multiple peaks, characteristic frequency was defined as the frequency at the most sensitive tip (i.e., with lowest threshold). Response bandwidths 20 dB above threshold of tuning curves (BW20s) were measured for all sites. The response latency was defined as the time from stimulus onset to the earliest response, using peri-stimulus time histograms of responses to all tone pips.

The overall boundaries of the A1 were functionally determined using non-responsive sites and responsive sites that did not have a well defined pure tone-evoked response area (i.e., non-A1 sites). To generate A1 maps, Voronoi tessellation (a Matlab routine, The MathWorks, Natick, Mass.) was performed to create tessellated polygons, with electrode penetration sites at their centers. Each polygon was assigned the characteristics (i.e., CF) of the corresponding penetration site. In this way, every point on the surface of the auditory cortex was linked to the characteristics experimentally derived from a sampled cortical site that was closest to this point.

To document cortical tMTFs, trains of 6 tonal pulses (25 ms duration with 5 ms ramps at 60 dB SPL) were delivered four times at each of 8 repetition rates (2, 4, 7, 10, 12.5, 15, 17.5, and 20 pps) in a randomly interleaved sequence. The tone frequency was set at the CF of each site. To reduce the variability resulting from different numbers of neurons included in different multi-unit responses recorded, the normalized cortical response for each repetition rate was calculated as the average response to the last five pulses divided by the response to the first pulse. The tMTF is the normalized cortical response as a function of the temporal rate. The cortical ability for processing repetitive stimuli was estimated with the highest temporal rate at which the tMTF was at half its maximum (f_{h1/2}).

Vector strength (34-36) was calculated using the following equation:

vector strength=(1/n){square root over (Σ (cos(2πtᵢ/T))²+Σ sin(2πtᵢ/T))²)}, where n=total number of spikes, tᵢ(i=1, 2 . . . n) is the time between the onset of the first pulses and the i^{th} spike, and T is the inter-stimulus interval. Spikes that occurred during a 6T period after the onset of the first tonal pulse were included to compute vector strength.

The degree of synchronization between cortical sites was assessed by recording in silence for 10 periods of 10 s spontaneous neuronal spikes from two to four electrodes simultaneously. Cross-correlation functions were computed from each electrode pairs by counting the number of spikes coincidences for time lags of −50 to 50 ms with 1 ms bin size and were normalized by dividing each of its bins by the square root of the product of the number of discharges in both spike trains. Neural events occurring within 10 ms of each other in two channels were considered synchronous. The degree of synchronization may be correlated with spike rates in a nonlinear manner. For each pair of spike trains, we estimated the number of synchronized events if the two spike trains were not correlated, using N_{A}N_{B}ΔT, where N_{A} and N_{B} are the numbers of spikes in the two spike trains, Δ (=21 ms) is the bin size, and T is the duration of the recording. The strength of the synchrony was then assessed using a Z-score of the number of synchronous events:

$$Z = \frac{( number of synchronized events - \frac{{N}_{A} {N}_{B} Δ }{T} )}{\sqrt{\frac{{N}_{A} {N}_{B} Δ}{T}}} .$$

For neural synchrony recording, offline spike sorting using TDT OpenSorter (Tucker-Davis Technology, Alachua, Fla.) was performed to include only single units in the analysis.

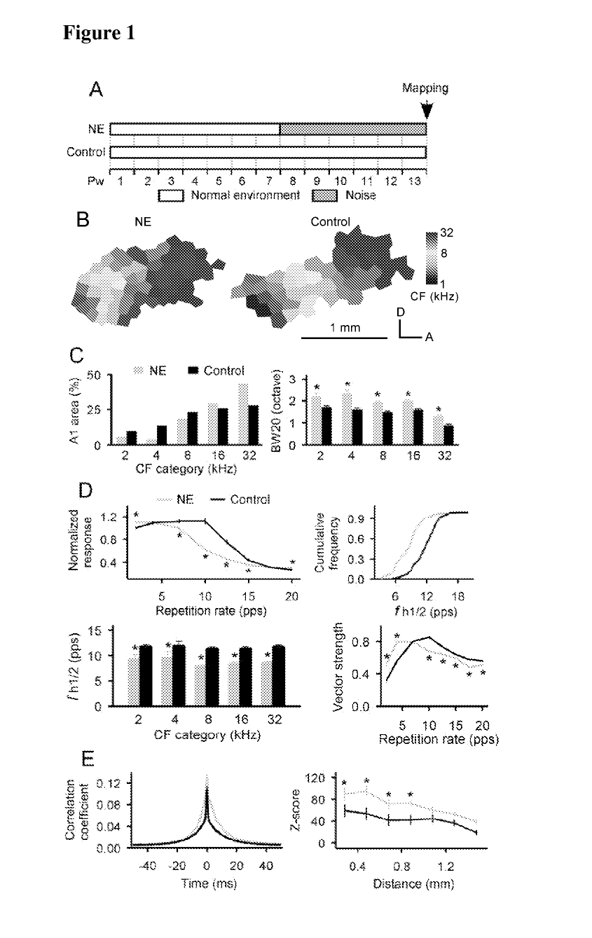

Quantitative immunoblotting and ELISA. NE and naïve control rats used for quantitative immunoblotting and ELISA were not those used for electrophysiological experiment but were otherwise treated in the same way (FIG. 1A). Rats were anaesthetized with an i.p. injection of sodium pentobarbital (50 mg/kg body weight), and the overall boundaries of the right A1 were functionally determined using electrophysiological recording procedures as above Animals were then deeply anaesthetized with an additional dose of sodium pentobarbital. The right A1 and the visual cortex were rapidly dissected, frozen in dry ice and stored at −80° C. until processing.

For quantitative immunoblotting analysis, synaptoneurosomes were prepared as described (Hollingsworth E B et al. (1985) J. Neurosci. 5:2240-2253) with slight modifications. Equal amounts of synaptoneurosomal proteins (7-10 μg), determined using the BCA assay (Pierce, Rockford, Ill.), were resolved in 4-15% polyacrilamide gels and transferred to PVDF membranes. Membranes were probed with primary antibodies, followed by the appropriate secondary antibody conjugated with infrared dyes (LI-COR Biosciences, Lincoln, Nebr.). Primary antibodies used were anti-GABA_{A}α1 (1:200, Chemicon, Temecula, Calif.), anti-GABA_{A}β⅔ (1:1000, Upstate, Dundee, UK), anti-myelin basic protein (MBP) (1:500, USBiological, Swampscott, Mass.), anti-GluR2 (1:500, Chemicon, Temecula, Calif.), anti-NR2a (1:400, Upstate, Dundee, UK), anti-NR2b (1:1000, Upstate, Dundee, UK), anti-actin (1:1000, Chemicon, Temecula, Calif.) and anti-γ-tubulin (1:1000, Sigma, St. Louis, Mo.). Immunoreactive bands were visualized and quantified using Odyssey Infrared Imaging System (LI-COR Biosciences, Lincoln, Nebr.). The relative levels of each protein were calculated as a ratio against either actin or γ-tubulin, normalized to those of naïve controls run in the same gel. Alternatively, the ratio of NR2a/NR2b were used and normalized in the same way.

For the determination of brain-derived neurotrophin factor (BDNF) levels, fragments of the A1 were lysed and acidified as described (Okragly A J et al. (1997) Exp. Neuro. 145:592-596). Total protein concentrations were determined using the BCA assay (Pierce, Rockford, Ill.). BDNF was quantified using an ELISA kit (Human BDNF Quantikine Kit, R&D Systems, Minneapolis, Minn.) as per the manufacturer's protocol.

For all assays, the researcher was blind to the group identity of the samples.

### Example 1

### Changes in Cortical Response S Following Chronic Noise Exposure

In an initial experimental series, rats were exposed to continuous, moderately intense (65 dB SPL) white noise over a 6-week period beginning at postnatal week 8 (Pw8). Highly significant differences in frequency tuning, temporal response characteristics and response coordination were documented in A1 in these noise exposed (NE) rats (N=7) versus age-matched naïve control rats (N=9) reared under standard, quiet housing conditions (FIG. 1, panel A).

A1 was relatively topographically (tonotopically) organized in control rats, with isofrequency bands oriented approximately orthogonal to a systematic rostro-caudal frequency representation gradient. A1 tonotopy was distorted in NE rats, to proportionally exaggerate and proportionally reduce the territories representing higher and lower frequencies, respectively (FIG. 1, panel B; NE vs. control). The percentages of A1 areas tuned to different frequency ranges are shown at the left in FIG. 1, panel C. The A1 zones best-representing frequency ranges centered at 16 and 32 kHz were significantly larger but the zones best representing frequency ranges centered at 2, 4 and 8 kHz were smaller in NE than in control rats (χ²-test, p=0.033).

Neurons all across A1 responded less selectively (neurons were less sharply tuned) to sound frequencies in NE than in control rats. The tuning curve bandwidths measured 20 dB above threshold (BW20s) provided an index of that frequency selectivity, which was significantly and systematically degraded by this chronic noise exposure (FIG. 1, panel C, right; t-test, all p<0.00012). In addition, cortical response thresholds for tonal stimuli were lower in NE than in control rats (19.2±0.5 dB SPL vs. 25.6 ±0.7 dB SPL; t-test, p<0.00001). Response latencies did not significantly differ between the two groups (11.4±0.08 ms for NE rats and 11.5±0.08 ms for control rats; t-test, p=0.39).

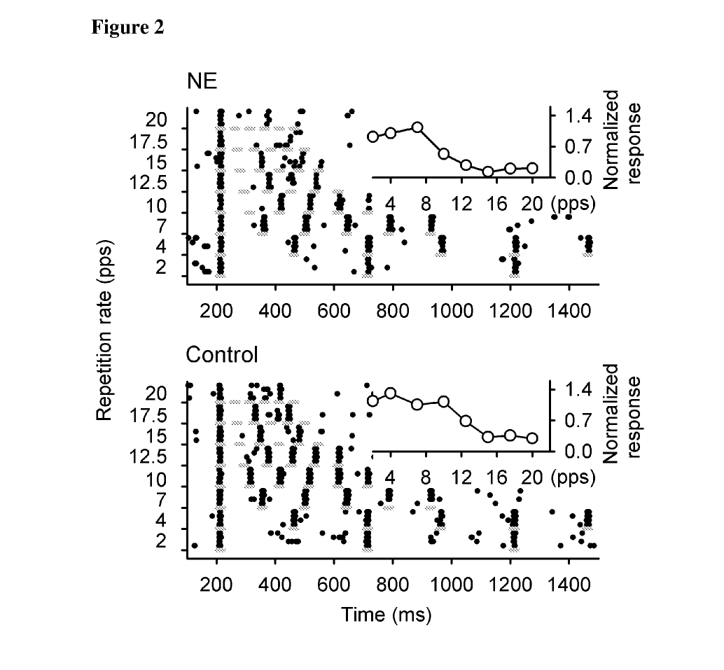

Temporal responses in A1 of both rat groups were also examined by recording cortical responses to characteristic frequency (CF) tonal pulses delivered at variable rates. In control rats, most cortical neurons could follow repeated stimuli at and below rates of 10 pulses per second (pps) with each successive tone pulse evoking a similar number of spikes as did the first tone in the train. By contrast, most A1 neurons in NE rats only followed stimuli at or below 7 pps (FIG. 2; NE vs. control). For temporal modulation-transfer functions (tMTFs), in which normalized cortical responses were defined as a function of stimulus repetition rates (FIG. 2, inserts), responses decreased at high repetition rates (i.e., 7-15 pps) in NE compared to control rats (FIG. 1, panel D, upper left; t-test, p<0.02-0.00001). A comparison of the distributions for the highest temporal rates at which tMTF was at half of its maximum (f_{h1/2}, a measure of the cortical capacity for processing high rate stimuli) also showed a significant leftward shift for NE versus control rats (FIG. 1, panel D, upper right; Kolmogorov-Smirnov test, p<0.001), again demonstrating the decreased rate-following ability induced by noise exposure, for neurons across all CF ranges (FIG. 1, panel D, lower left; t-test, p<0.0013-0.00001).

To characterize the precision of spike timing relative to stimulus phases, vector strengths were calculated, which quantify the degree of phase locking of neural responses to successive, identical stimuli. Although the average vector strengths as a function of stimulus repetition rates followed the same band-pass patterns for both rat groups, the curve was again shifted leftward and peaked at lower repetition rates in NE versus control rats (4 pps vs. 10 pps; FIG. 1, panel D, lower right). Note that vector strengths were smaller at high repetition rates, but larger at low rates, in NE versus control rats (t-test, p<0.008-0.00001).

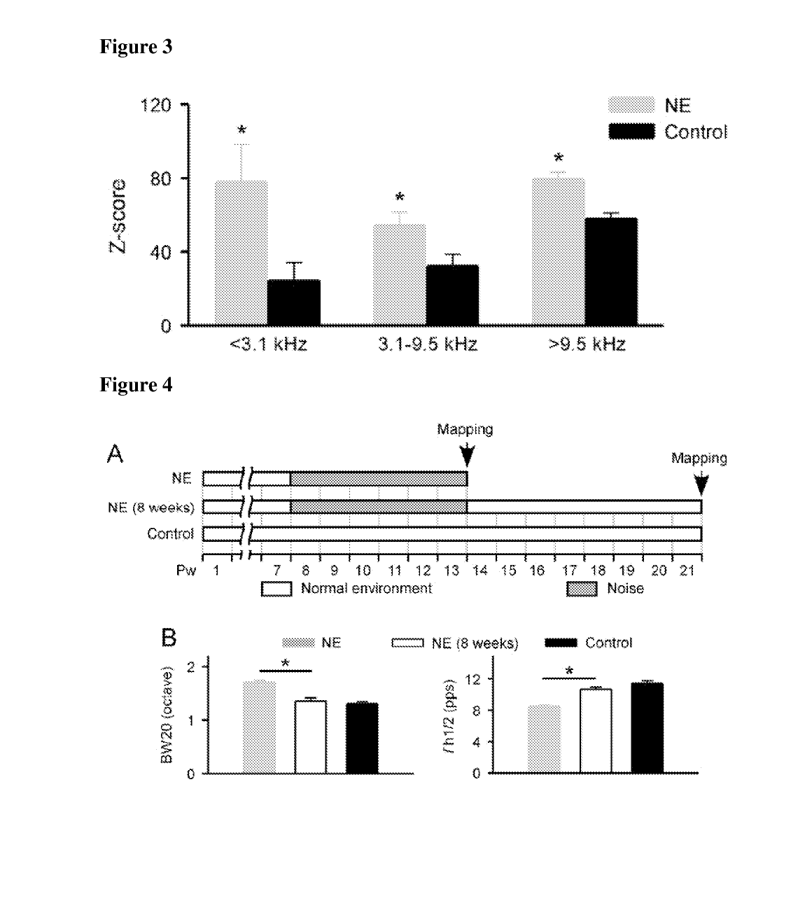

Neural synchrony was documented in A1 by simultaneously recording spike activity during spontaneous activity periods from neurons within cortical layers 4/5 separated by variable cortical distances (282 recording pairs from 4 NE rats; 318 pairs from 5 control rats). All spikes that occurred in two recording channels within 10 ms of one another were considered to be synchronized events. As shown in left of FIG. 1, panel E, the average correlograms normalized for firing rates between −10 and 10 ms lags differed significantly between the two groups (0.061±0.009 for NE rats and 0.039±0.006 for control rats; t-test, p<0.00001), with a wider temporal dispersion recorded in NE rats. The distributed patterns of spontaneous activity correlation reflecting distributed cortical network coupling also differed significantly between them. In the analysis, the observed frequency of occurrence of synchronized events for the two neurons was corrected for the expected chance occurrence of a synchronous event. The resulting average Z-score for pairs of simultaneously recorded cortical sites in both groups decreased as a function of inter-electrode distances (FIG. 1, panel E, right; ANOVA, both p<0.0001). However, values were higher at all electrode separations, and correlations were recorded over longer cortical distances in NE than in control rats (t-test, all p<0.0005 for separations ranging from 0.3 to 0.9 mm). Induced changes applied for cortical zones representing low-(<3.1 kHz), middle-(3.1-9.5 kHz), and high-(>9.5 kHz) frequencies (FIG. 3; t-test, p<0.035-0.00001).

### Example 2

### Restoration of Normal Response Properties for Noise-Exposed Rats After Being Returned to a Normal Environment

To determine the long-term impacts of noise exposure on A1 response properties, three additional NE rats were returned to a normal auditory environment and mapped eight weeks after the end of noise exposure (FIG. 4, panel A). BW20 and f_{h1/2} were measured and compared with data from NE rats recorded immediately after exposure, as well as with data from aged-matched control rats (N=5). These properties significantly differed (were again reversed) from those recorded immediately after exposure (ANOVA with post-hoc Student-Newman-Keuls test, both p<0.001; FIG. 4, panel B), and were now comparable to data from normal, never-exposed control rats (ANOVA with post-hoc Student-Newman-Keuls test, both p>0.05). These results manifest a restoration of normal response properties for NE rats after their return to a normal acoustic environment for eight weeks.

### Example 3

### Noise Exposure Reinstates Corticl Period Plasticity in A1

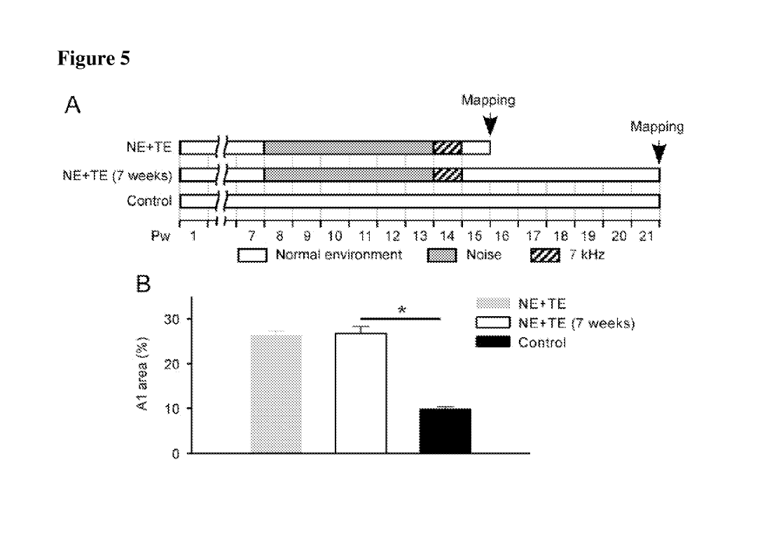

In the data described to this point, NE rats were exposed to continuous noise beginning at Pw8. At this age, the rat is approaching sexual maturity, and A1 has matured far beyond the normal closure of the critical period window for passive sound-exposure-driven plasticity. Since tone-specific enlargement in A1 representation resulting from transient exposure to sound stimuli is a basic index of critical period plasticity, the post-critical period status of rats at this age was confirmed by exposing them to pulsed 7-kHz tone pips over a one-week-long epoch (FIG. 5, panel A). In striking contrast to rats in the normal early critical period, that exposure resulted in no measurable alteration of A1 tonotopy (FIG. 5, panel B).

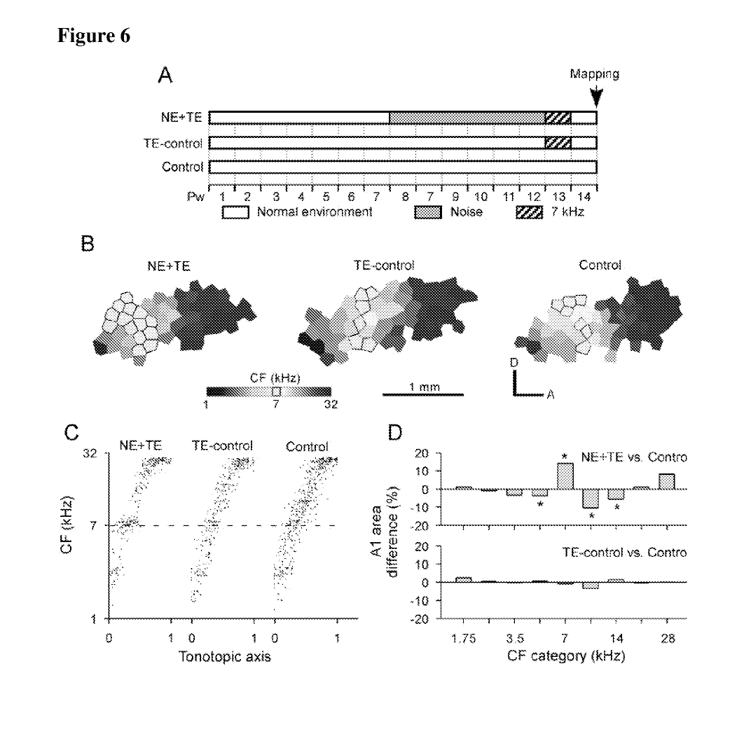

A subset of NE rats (N=7) were exposed to pulsed 7-kHz tones for one week, beginning at the end of their noise exposure epoch (these rats were thus defined as noise exposed plus tone exposed rats, i.e., NE+TE rats; FIG. 6, panel A). As an additional control, another group of age-matched naïve rats (N=7) were also exposed to pulsed 7-kHz tones over the same epoch (i.e., TE-control rats; FIG. 6, panel A). The A1 zone that selectively responded to 7 kHz was enlarged by mere sound exposure in these NE+TE rats compared to age-matched non-sound-exposed control rats (N=12; FIG. 6, panel B, NE+TE vs. control), just as it is in infant critical period rats. This frequency-specific distortion in A1 is illustrated in a second way in FIG. 6, panel C, where CFs of all recording sites from each group of rats were plotted against a normalized tonotopic axis. Examination of the CF distribution revealed an over-representation of sites tuned to 7 kHz, and a relative under-representation of sites tuned to immediately lower and higher sound frequencies for NE+TE rats, when compared to control rats (FIG. 6, panel C; NE+TE vs. control). To quantitatively characterize the effects of pulsed tone exposure on A1 frequency representation, the percentages of A1 areas representing each frequency range were averaged within the same experimental group and the differences between exposed and control animals plotted (FIG. 6, panel D). Average percentages of A1 areas tuned to 7 kHz±0.25 octave in NE+TE rats were very significantly increased compared to control rats (FIG. 6, panel D, NE+TE vs. control; t-test, p<0.00001). It was noted that the magnitudes of these sound exposure induced changes parallel those resulting from a matched period of exposure in the critical period in infant rats. As in those infants, the percentages of A1 areas tuned to frequencies that were just below or just above the exposed tone frequency were also reduced (t-test, p<0.038-0.005). It is also important to note that the maps and CF distributions in TE-control rats were not statistically distinguishable from those recorded in completely naïve, age-matched controls (FIG. 6, panels B, C, and D; TE-control vs. control).

### Example 4

### Cortical Plasticitiy Changes in Old Rats

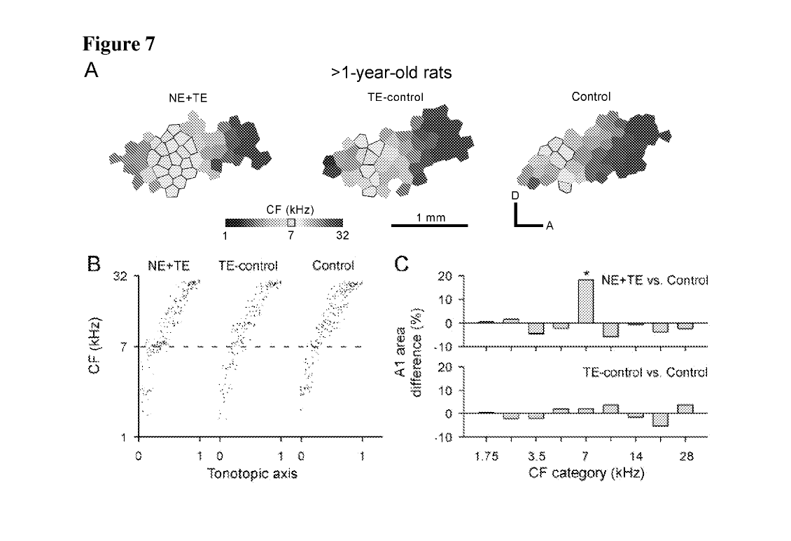

To examine whether noise exposure would induce the same plastic changes in A1 in older rats, the noise exposure protocol was initiated in a second series of experiments conducted in one-year-old animals. These rats were again exposed to 7 kHz tonal stimuli immediately after the noise-exposure epoch (FIG. 7, panel A). A dramatic frequency-specific distortion in A1 was again evoked by mere passive sound exposure, in NE+TE rats but not in TE-control rats, with both groups again indexed by data from completely naïve non-exposed rats of the same age (FIG. 7, panels A, B, and C).

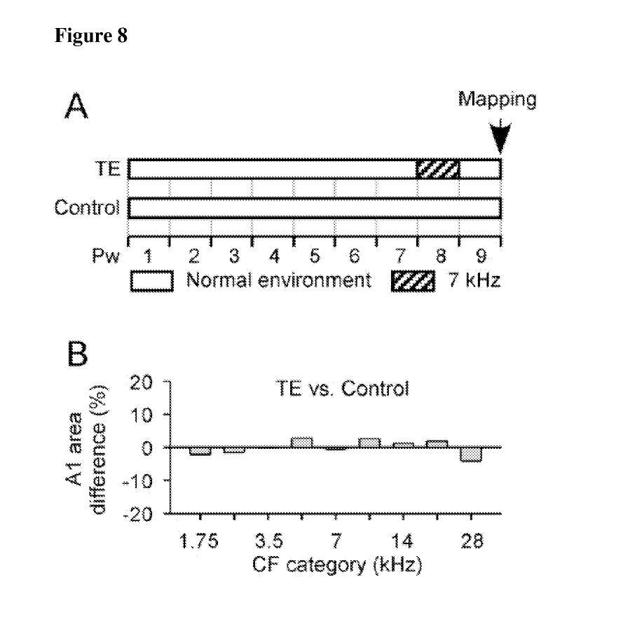

Cortical changes induced by passive sound exposure during the critical period in infants are known to be relatively long-enduring. To evaluate the long-term impacts of tone exposure on cortical representations in the new sensitive period induced in NE rats, four NE+TE rats were returned to a normal auditory environment and mapped 7 weeks later (FIG. 8, panel A). Percentages of A1 areas tuned to 7 kHz±0.25 octave for these NE+TE rats were comparable to those of NE+TE rats measured one week after the end of the tone exposure (FIG. 8, panel B; ANOVA with post-hoc Student-Newman-Keuls test, p>0.05) but significantly larger than that of control rats (ANOVA with post-hoc Student-Newman-Keuls test, p<0.001). Thus, as in the early postnatal critical period, the plasticity changes induced by tonal exposure following noise exposure persisted with little change for up to at least 7 weeks after that exposure.

### Example 5

### Molecular Changes in A1 Induced by Noise Exposure

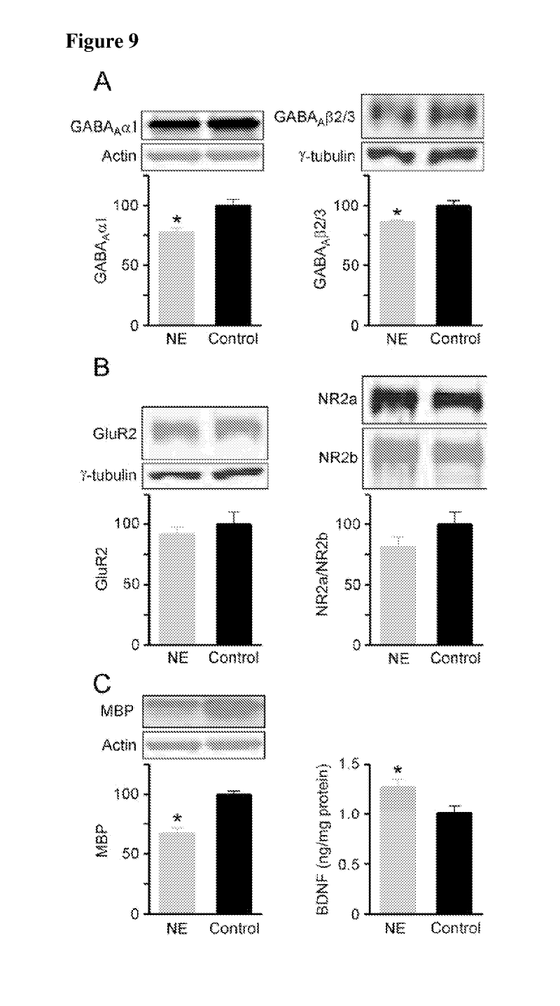

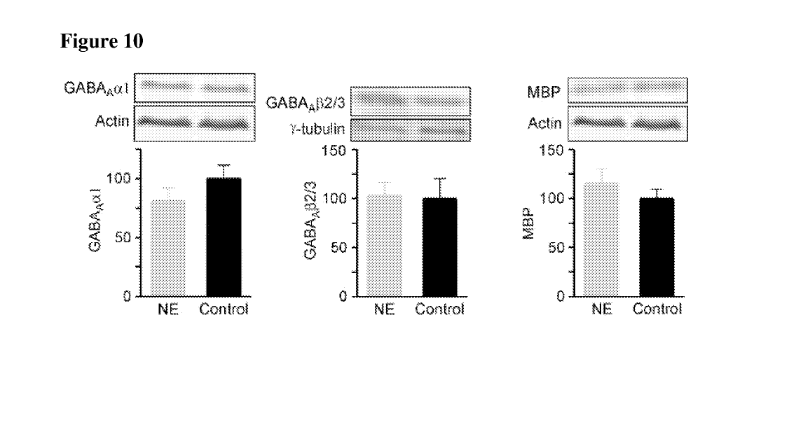

To begin to document the auditory system changes that paralleled the re-establishment of the critical period, levels of cortical inhibition and excitation were documented in NE and control rats by using quantitative immunoblotting. Antibodies that recognize α1 and β⅔ subunits of gamma-aminobutyric acid A (GABA_{A}) receptors were used to assay changes in cortical inhibition. Antibodies that recognize the GluR2 subunit of alpha-amino-3-hydroxy-5-methyl-4-isoxazole propionate (AMPA) receptors and the NR2a and NR2b subunits of N-methyl-D-aspartate (NMDA) receptors were used to track changes in cortical excitation. Quantitative immunoblotting revealed a significant decrease in expression levels of both oil and ⅔ for NE rats compared to control rats (FIG. 9, panel A; t-test, both p<0.004). Changes in GluR2, or in the ratio of NR2a/NR2b of NE rats versus control rats did not reach the level of statistical significance (FIG. 9, panel B; t-test, both p>0.17). Cortical myelin basic protein (MBP) levels were also measured using quantitative immunoblotting, and brain-derived neurotrophin factor (BDNF) levels using an enzyme-linked immunosorbent assay (ELISA). A decreased expression of MBP and an increased expression of BDNF were recorded in cortical field A1 of NE rats compared to control rats (FIG. 9, panel C; t-test, p=0.0002 for MBP and 0.04 for BDNF). These molecular changes in A1 were all substantially or completely reversed to normal adult titers by returning NE rats to a normal acoustic environment for eight weeks after the end of noise exposure (N=6 of NE rats and N=5 of control rats for each group; t-test, all p>0.06). As an intra-brain control, the expression levels of α1, β⅔ and MBP were quantified in the occipital visual cortex in NE and control rats. No significant differences were seen (FIG. 10; t-test, all p>0.26).

Discussion

For more than 50 years, the neuroscience mainstream has viewed brain development as a multiple-stage process that begins with a pre-critical period epoch, advances into a relatively short-duration, highly plastic critical period, then progresses relatively abruptly into a third aplastic or less plastic adult phase. That critical period is usually described as a developmental stage during which mere exposure to visual or sound or tactual or other stimuli drives substantial neurological specialization or change. The evidence provided herein supports a major revision in our understanding of these change progressions: at least most of the very complex chemical, physical and functional changes resulting in the transition to an adult stage are, by their nature, reversible.

In this study, a great capacity for naturally driving “negative” cortical changes was documented when post-critical period rats were exposed over a several-week-long period to continuous, moderate-level noise. A wide range of fundamental plastic changes in excitatory and inhibitory neuronal processes were here documented to occur in the cortex, and in most respects, after this exposure, A1 re-acquired characteristics that apply for this cortical area in the critical period in a less mature (infantile) state. A1's inhibitory processes were down-regulated; it was producing less myelin (MBP); a primary trophic factor that contributes critically to vigorous critical period plasticity, BDNF, was again up-regulated; spectral responses were less selective; representational topography favored high and disfavored low frequency representations; temporal responses were sluggish, and imprecise at higher input rates; cortical activities were more temporally and spatially dispersed. All of these aspects of cortical function and structure moved in the direction of the “more immature” A1. Moreover, this complex series of changes was again paralleled by an emergent sound-exposure-sensitive epoch—a new “critical period”—in these rats. The plastic distortion induced in juvenile animals was of the same magnitude as that generated in an infant critical period rat. This sound exposure-induced remodeling endured in the cortex, just as it does when induced in the infant critical period. Identical reversals in the indices of cortical maturation were also recorded in older rats, strongly indicating that these many aspects of cortical maturation can regress at any age in life. On the other hand, when the cortex was allowed to again progress in its organization by returning the animal back to a normal acoustic environment, A1 again evolved back to an adult status reflected by a re-reversal of the indices of maturity described above—changing in them, just as it does in the transition from the critical period to the adult stage, in a normal early life.

Chronic passive exposure to a special form of noise (very rapid, randomly delivered tonal stimuli) can result in broadened frequency tuning and increased neuronal synchrony in A1 zone representing frequencies of exposed tones in adult cats. In this study the noise-induced changes actually re-opened a new sensitive or critical period, and a wide array of complex changes were found to be reversed by returning these young now-adult animals into a normal acoustic environment. The recovery from the “negative plasticity” changes induced by noise were distinguished from the positive, persistent cortical changes induced by transient sound exposure during the critical period, in that the latter changes do not rapidly fade, but to the contrary, persist long after they are induced.

The degree of critical period-like plasticity is believed to be a titrated function of the level of GABA_{A} activity. Cortical inhibition can also play an important role in shaping neuronal processing in A1, as in the visual cortex. The mature, functionally-differentiated cortex, with its strongly and powerfully-selective inhibitory processes in place, responds with greater cooperativity, reliability and predictably. This study indicates that the processes degrading GABA_{A} inhibition and therefore enabling plasticity trade off against response reliability and stability, and indicates that this tradeoff is subject to continuous fluctuation over the course of a lifetime. Ongoing studies are designed to define strategies for manipulating this “set point” for plasticity in older brains, and for further elucidating the many theoretical and practical implications of these findings.

Finally, it should be noted that this study also illustrates potentially destructive consequences of even moderate-level noise exposure for the representations of auditory

GABAergic inhibition, NMDA receptors, and BDNF can play important roles in regulating or enabling changes that express that transition. Here, we recorded reversible changes in both GABA_{A} α1 and β⅔ subunits; BDNF. It might be noted that one index of cortical maturity measured in this study, the proportional levels of expression of NMDA receptor NR2a and NR2b subunits did not change following noise exposure.

In the visual cortex, reduction of GABAergic inhibition can re-open a period of stimulus exposure-based plasticity, revealing a conserved potential for plasticity carried into adulthood. Similarly, returning older rats to continuous darkness can also re-open an epoch of ocular dominance plasticity. Again, changes in GABA_{A} inhibitory processes were recorded in parallel with this apparent critical period re-opening. The embryonic Otx2 homeoprotein controls changes in parvalbumin GABA_{A} neurons that may open and close the critical period in the visual cortex. Changes in A1 responses following noise exposure (i.e., degraded frequency tuning and more sluggish temporal responses) are similar to those resulting from reduced cortical GABAergic inhibition. Immunoblotting data revealing a decrease in the expression level of GABA_{A} α1 and β⅔ subunits in A1 of NE rats, and the restoration of their levels after the post-noise-exposure recovery of these inhibition-dependent response characteristics all support this conclusion that parvalbumin-containing neurons and other processes involving GABA_{A} receptors have also been weakened by chronic noise exposure. The precision of neuronal synchronization is also influenced by the status of GABAergic inhibition. Synchronization as a function of cortical distance is a function of the degree of receptive field overlap across cortical networks. Thus, the changes in the precision and distribution of coordinated responses recorded here are also both consistent with cortical “detuning” arising from, or at least paralleled by the significantly weakening of GABA_{A} inhibition.

In addition, noise exposure was found to reduce the expression level of cortical MBP, another marker of the progression from an infantile to the mature cortical status. Myelination can also play a key role in the regulation of CNS plasticity. During early development, its elaboration at the end of the critical period actively suppresses mere exposure-driven plasticity, and in the mature nervous system, myelin proteins are potent but reversible inhibitors of axonal re-growth and new synapse formation after injury. The decrease in MBP observed in A1 after noise exposure suggests that myelin levels are actively and continuously regulated in the cortex in an activity-dependent manner to promote or limit permissive states of stimulus exposure-driven change. Based on the study presented herein, intracortical myelination can increase the timing precision of the neuro-modulation of plasticity, thus contributing to the enabling of learning context-, outcomes-dependent plasticity, which is another consequence of the transition to adult plasticity.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method for inducing brain plasticity in an individual comprising:
presenting to said individual continuous noise over a period of time; and
providing said individual with tone sensitivity training or language training.

2. The method of claim 1, wherein said noise is structured noise.

3. The method of claim 1, wherein said period of time is about 6 weeks.

4. The method of claim 1, wherein said individual is about 20 months or younger.

5. The method of claim 1, wherein said individual has suffered or is suffering from a neurological injury.

6. The method of claim 1, wherein said individual is dyslexic.

7. The method of claim 1, wherein said method increases adaptability of auditory cortex in said individual.

8. The method of claim 1, wherein said noise is presented at about 65 dB.

9. The method of claim 1, wherein said method further comprises placing said individual in a normal auditory environment after said presenting step.

10. The method of claim 1, wherein presenting is done by a cochlear implant.

11. A cochlear implant that performs the method of claim 1.

12. A computer accessible memory medium comprising program instructions for inducing brain plasticity in a subject, wherein said execution of said instructions causes a device to perform the method of claim 1.

13. A method for inducing brain plasticity in an individual comprising:
executing an instruction in an electronic device to present to said individual continuous noise over a period of time; and
executing an instruction in an electronic device to provide said individual with tone sensitivity training or language training.

14. The method of claim 13, wherein said noise is structured noise.

15. A computer-readable storage medium for inducing brain plasticity in an individual, comprising instructions executable by at least one processing device that, when executed, cause the processing device to:
(a) present to the individual with continuous noise over a period of time; and
(b) provide said individual with tone sensitivity training or language training.

16. The computer-readable storage medium of claim 15, wherein said noise is structured noise.

17. The computer-readable storage medium of claim 15, wherein said period of time is about 6 weeks.

18. The computer-readable storage medium of claim 15, wherein said noise is presented at about 65 dB.
